(19) United States
(12) Patent Application Publication
(10) Pub. No.: US 2026/0236506 A1
(43) Pub. Date: Aug. 13, 2026

(54) AUGMENTED DATA RETRIEVAL FROM A DATA SOURCE USING RETRIEVAL-AUGMENTED GENERATION (RAG) MODELING

(71) Applicant: Dappier Inc., Austin, TX (US)

(72) Inventors: Krishna Arvapally, Cedar Park, TX (US); Daniel Goikhman, Lakeway, TX (US); Akshay Arvapally, Pflugerville, TX (US)

(21) Appl. No.: 19/282,977

(22) Filed: Jul. 28, 2025

Related U.S. Application Data
(60) Provisional application No. 63/757,176, filed on Feb. 11, 2025.

(51) Int. Cl. G06F 16/334; G06F 9/451

(52) U.S. Cl. CPC G06F 16/334; G06F 16/9535

(57) ABSTRACT

Embodiments of the present disclosure provide for providing augmented data retrieval from a data source using retrieval-augmented generation (RAG) modeling. Such embodiments may include receiving a data retrieval request associated with a user query from a large language model, applying a RAG model to data associated with the data retrieval request to determine real-time knowledge data for a query response associated with the user query, applying a fine-tuned data augmentation model to the data associated with the data retrieval request to determine contextual data associated with the data retrieval request, querying a user interface (UI) content element database based on the contextual data to determine a UI content element for the query response, and generating a data retrieval response for the large language model that comprises (i) the real-time knowledge data and (ii) the UI content element for the query response.

### CROSS REFERENCE TO RELATED APPLICATIONS

This application claims priority to U.S. Appl. No. 63/757,176 filed Feb. 11, 2025, the contents of which are incorporated herein in its entirety by reference.

### TECHNOLOGICAL FIELD

Embodiments of the present disclosure generally relate to artificial intelligence modeling, and more particularly to retrieval-augmented generation and memory-contextual processing modeling.

### BACKGROUND

An artificial intelligence (AI) model such as a large language model is typically trained based a training dataset comprising a vast amount of data. After the training, the trained AI model is typically queried to retrieve data using the static knowledge obtained during the training. However, Applicant has discovered problems with current AI systems and/or AI modeling techniques that result in poor performance of the underlying computing systems. Through applied effort, ingenuity, and innovation, Applicant has solved many of these identified problems by developing embodied in the present disclosure, which are described in detail below.

### BRIEF SUMMARY

Various embodiments described herein relate to apparatus(es), method(s), system(s), and/or computer program product(s) for providing augmented data retrieval from a data source using retrieval-augmented generation (RAG) modeling.

In an embodiment, an apparatus comprises one or more processors and one or more storage devices storing instructions that are operable, when executed by the one or more processors, to cause the one or more processors to receive, from a large language model, a data retrieval request associated with a user query. The instructions are additionally or alternatively operable, when executed by the one or more processors, to cause the one or more processors to apply a RAG model to data associated with the data retrieval request to determine real-time knowledge data for a query response associated with the user query. The instructions are additionally or alternatively operable, when executed by the one or more processors, to cause the one or more processors to apply a fine-tuned data augmentation model to the data associated with the data retrieval request to determine contextual data associated with the data retrieval request. The instructions are additionally or alternatively operable, when executed by the one or more processors, to cause the one or more processors to query a user interface (UI) content element database based on the contextual data to determine a UI content element for the query response. The instructions are additionally or alternatively operable, when executed by the one or more processors, to cause the one or more processors to generate a data retrieval response for the large language model that comprises (i) the real-time knowledge data and (ii) the UI content element for the query response.

In another embodiment, a computer-implemented method provides for receiving, from a large language model, a data retrieval request associated with a user query. In one or more embodiments, the user query comprises text, audio (e.g., voice audio content, etc.), video, haptic data, gesture data associated with one or more gestures, and/or a combination thereof. The computer-implemented method additionally or alternatively provides for applying a RAG model to data associated with the data retrieval request to determine real-time knowledge data for a query response associated with the user query. The computer-implemented method additionally or alternatively provides for applying a fine-tuned data augmentation model to the data associated with the data retrieval request to determine contextual data associated with the data retrieval request. The computer-implemented method additionally or alternatively provides for querying a UI content element database based on the contextual data to determine a UI content element for the query response. The computer-implemented method additionally or alternatively provides for generating a data retrieval response for the large language model that comprises (i) the real-time knowledge data and (ii) the UI content element for the query response. In one or more embodiments, the UI content element comprises text, audio (e.g., voice audio content, etc.), video, haptic data, and/or a combination thereof. In some embodiments, the UI content element and the user query comprise a corresponding type of content. For example, the UI content element and the user query may both comprise text. In some embodiments, the UI content element comprises a different type of content than the user query. For example, the user query may comprise text and the UI content element may comprise audio and/or video. In another example, the user query may comprise audio (e.g., voice audio content) and the UI content element may comprise text and/or video.

In yet another embodiment, one or more non-transitory computer-readable storage media store instructions that, when executed by one or more processors, cause the one or more processors to receive, from a large language model, a data retrieval request associated with a user query. The instructions, when executed by the one or more processors, additionally or alternatively cause the one or more processors to apply a RAG model to data associated with the data retrieval request to determine real-time knowledge data for a query response associated with the user query. The instructions, when executed by the one or more processors, additionally or alternatively cause the one or more processors to apply a fine-tuned data augmentation model to the data associated with the data retrieval request to determine contextual data associated with the data retrieval request. The instructions, when executed by the one or more processors, additionally or alternatively cause the one or more processors to query a UI content element database based on the contextual data to determine a UI content element for the query response. The instructions, when executed by the one or more processors, additionally or alternatively cause the one or more processors to generate a data retrieval response for the large language model that comprises (i) the real-time knowledge data and (ii) the UI content element for the query response.

Various other embodiments are also described in the following detailed description and in the attached claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Having thus described the embodiments of the disclosure in general terms, reference now will be made to the accompanying drawings, which are not necessarily drawn to scale, and wherein:

FIG. 1 illustrates a block diagram of a system that can be specially configured within which at least one example embodiment of the present disclosure may operate;

FIG. 2 illustrates a block diagram of an example apparatus that can be specially configured in accordance with at least one example embodiment of the present disclosure;

FIG. 3 illustrates an example data flow system as part of a process for providing augmented data retrieval from a data source using retrieval-augmented generation (RAG) modeling and/or memory-contextual processing (MCP) modeling in accordance with at least one example embodiment of the present disclosure;

FIG. 4 illustrates another example data flow system as part of a process for providing augmented data retrieval from a data source using RAG modeling and/or MCP modeling in accordance with at least one example embodiment of the present disclosure;

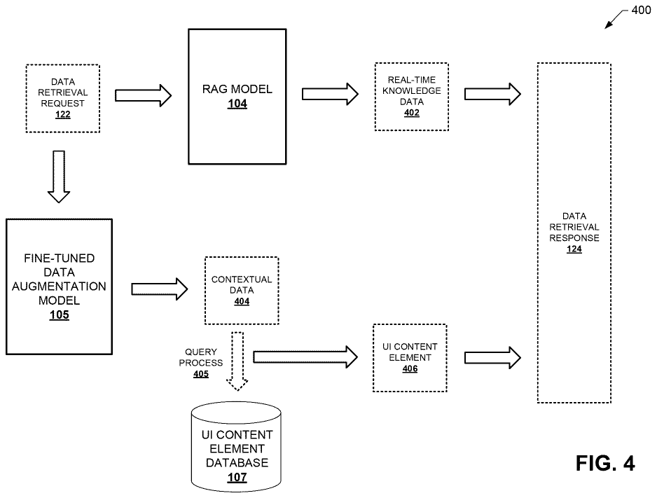

FIG. 5 illustrates an example augmented query response in accordance with at least one example embodiment of the present disclosure;

FIG. 6 illustrates an example electronic interface response in accordance with at least one example embodiment of the present disclosure; and

FIG. 7 illustrates a process depicting example operations for providing augmented data retrieval from a data source using RAG modeling and/or MCP modeling in accordance with at least one embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure can be embodied in many different forms and should not be construed as limited to the embodiments set forth herein, rather, these embodiments are provided so that this disclosure will satisfy applicable legal requirements. Like numbers refer to like elements throughout.

### Overview

An artificial intelligence (AI) model such as a large language model may retrieve data at an inference stage based on pre-trained knowledge provided to the AI model during a training process. For instance, an AI model may encode a vast amount of information within neural network parameters of the AI model during a training process for the AI model. At an inference stage for the trained AI model, this encoded knowledge may be accessed and utilized in response to a query provided to the trained AI model. In some instances, the trained AI model may leverage attention mechanisms, contextual embeddings, and/or other deep learning network architectures to determine relevant information for a query response based on the neural network parameters.

However, utilizing a fixed training dataset during training of an AI model may result in static knowledge for an AI model where the static knowledge may become outdated for particular queries during an inference stage, particularly in domains with rapidly evolving information. Additionally, accessing external data sources for each query during an inference stage of an AI model may introduce latency and/or other inefficiencies for an AI model, especially for large-scale applications where an AI model receives a vast quantity of queries within an interval of time. Additionally, maintaining and updating knowledge databases for an AI model may involve significant computational and/or storage resources. For example, updating the AI model based on new data in the knowledge databases may involve repeated retraining or fine-tuning of an AI model, resulting in additional computational overhead and/or other performance inefficiencies for the AI model. The costs associated with per-query data access of an AI model may further include increased infrastructure requirements, higher energy consumption, and/or potential scalability limitations for an AI model. Such technical issues may further impact accuracy of predictions or other output provided by an AI model.

To account for these and/or other technical challenges related to less desirable AI model systems, embodiments of the present disclosure utilize augmented data retrieval from a data source using retrieval-augmented generation (RAG) and/or memory-contextual processing (MCP) modeling. For example, RAG and/or MCP modeling may be utilized to retrieve augmented data in real-time at an inferences stage for a large language model. The augmented data may include an augmented version of real-time knowledge data for a user query provided to the large language model. For example, RAG and/or MCP modeling may be utilized to determine real-time knowledge data in response to a user query provided to the large language model. Additionally, a fine-tuned data augmentation model may be utilized to determine contextual data associated with the user query to enable querying of a user interface (UI) content element database based on the contextual data. In some embodiments, the fine-tuned data augmentation model may utilize taxonomy, intent analysis, and/or predictive identity graphing to determine the contextual data. The querying of the UI content element database may enable determination of a UI content element for a query response associated with the user query. As such, the real-time knowledge data may be augmented with the UI content element for the query response. In some embodiments, a UI content element for a query response may be configured for rendering via an electronic interface of a user device communicatively couple to a large language model. Exemplary UI content elements include, without limitation, advertisements (e.g., advertisement comprising graphics and/or text), hyperlinks, notifications, videos, sounds, query responses configured based on UI content element information (e.g., the UI content element contextually embedded within a query response), etc.

In various embodiments, the RAG and/or MCP modeling may enable dynamic fetching of most relevant information for a user query provided to a large language model. Additionally, the fine-tuned data augmentation model may enable a scalable and enhanced query response for a large language model. In various embodiments, the RAG and/or MCP modeling may enable the large language model to access real-time, proprietary, and/or structured data sources to provide a more accurate and/or contextually relevant query response for the large language model. In various embodiments, the RAG and/or MCP modeling may optimally link real-time knowledge data to a large language model to enable seamless data retrieval on-demand. For example, the RAG and/or MCP modeling may fetch relevant and/or up-to-date knowledge data to enable optimal integration of the knowledge data into a query response for a large language model. In some embodiments, the RAG and/or MCP modeling may integrate real-time knowledge data and a UI content element into a data retrieval response that is transmitted to a large language model for enabling an augmented query response for the large language model. In some embodiments, a data retrieval response associated with real-time knowledge data and a UI content element may initiate one or more application programming interface (API) actions associated with a large language model. In some embodiments, a data retrieval response associated with real-time knowledge data and a UI content element may trigger retraining of a large language model.

In some embodiments, the MCP modeling may enhance the RAG modeling by integrating short-term contextual memory and long-term contextual memory for determining relevant real-time knowledge data associated with a user query. For example, the MCP modeling may retain contextual memory associated with historical interactions with a large language model and/or a real-time knowledge database. Additionally, the MCP modeling may adjust a query process for a real-time knowledge database based on conversation history associated with a large language model. The conversation history may include information associated with multiple user queries and/or multiple query responses for a large language model. The MCP modeling may also optimize multi-turn interactions with a large language model that involve multiple interactions between a user device and the large language model to provide more accurate and/or more personalized query responses via the large language model.

In some embodiments, the RAG and/or MCP modeling may be interoperable with multiple large language models and/or multiple types of large language models to enable the large language models to leverage memory-optimized data retrieval without continuous pre-training. As such, multiple large language models and/or multiple types of large language models may access and utilize the RAG and/or MCP modeling to enable a flexible and scalable artificial intelligence platform.

In some embodiments, the fine-tuned data augmentation model may enable a large language model to access real-time, proprietary, and/or structured data sources on a free or reduced cost basis by allocating incentives generated in connection with queries and usage of the system. For example, an incentive may be generated in connection with augmenting real-time knowledge data with a UI content element (e.g., an advertisement, a sponsored hyperlink, etc.) for a query response and that incentive may be allocated in whole or in part to data source providers to subsidize the query. An incentive may be based on a predicted degree of contribution for fulfilling a query via a query response with a UI content element. In some examples, the predicted degree of contribution may be based on a number of sources for a RAG model, document contribution for the UI content element, contextual relevance (e.g., a vector relevance score) for the UI content element, a token share for generating the UI content element, and/or other criteria for predicting a degree of contribution associated with the UI content element. In some embodiments, an incentive may be generated in response to a successful rendering of the UI content element via a query response. In some examples, the predicted degree of contribution may be based on a post-engagement action (e.g., a click, a conversion, etc.) with respect to the UI content element rendered via the query response. Incentives for a UI content element may also be aggregated for a particular interval of time (e.g., per day, per week, per month, etc.) to enable allocation of the incentives generated in connection with queries and usage of the system.

In some embodiments, the fine-tuned data augmentation model may enable a large language model to access real-time, proprietary, and/or structured data sources without per-query fees by augmenting real-time knowledge data with a UI content element for a query response. In some embodiments, the fine-tuned data augmentation model may enable provision of an incentive to a user identifier associated with a large language model based on utilization of a UI content element for a query response. The incentive may be a redeemable asset such as a monetary asset, a digital asset (e.g., a digital token), a reward, or another type of incentive. In some embodiments, tracking and/or incentive allocation associated with a UI content element for a query response may be provided via an attribution system for the large language model. For example, the attribution system may enable accurate identification and tracking of data utilized to augment a query response to enhance explainability, performance, and/or retraining of the large language model.

In a non-limiting example, an AI agent (e.g., a large language model) may receive a query that corresponds to “What is the latest new on Car Company A's stock performance?”. The query may be provided as input to a RAG model of a RAG framework to retrieve real-time data associated with the query. Additionally, a fine-tuned data augmentation model of the RAG framework may match a UI content element relevant to a topic of the query. The UI content element may then be utilized for a query response. The query response may be an AI-generated response for the query. Additionally, an incentive flow for the query response may include: an advertisement payment of $1.00 that is paid by an advertiser for the opportunity render the UI content element via the query response, a data access cost of $0.50 to access RAG data via the RAG model, a revenue distribution of $0.50 for a data provider that provides the UI content element for the query response, a system provider cost of $0.40 for providing the RAG framework (e.g., infrastructure, AI orchestration, UI content element matching, and/or attribution workflows), and a website host cost of $0.10 to embed an AI experience for the RAG framework via a network site.

Various embodiments of the present disclosure improve a large language model by providing for both improvements in efficiency as well as reductions in error, inconsistencies, and/or other problems associated with existing large language models. For instance, by utilizing one or more embodiments related to utilizing augmented data retrieval from a data source using RAG and/or MCP modeling as disclosed herein, a large language model can provide a query response for a user query within a desirable interval of time (e.g., real time, near-real time, etc.). In various embodiments, a large language model may provide relevant query responses with text output based on real-time knowledge data related to a particular context during the desirable interval of time, even in scenarios where the large language model is configured with static knowledge provided during a training process. A number of computing resource and/or a number of errors for executing a large language model may be further minimized by utilizing one or more embodiments related to utilizing augmented data retrieval from a data source using RAG and/or MCP modeling as disclosed herein. In some embodiments, a user interface visualization at an electronic interface may be optimally rendered to enable concurrent display of (i) text output associated with the real-time knowledge data and (ii) a UI content element associated with an augmented query response for a user query.

### Example Systems

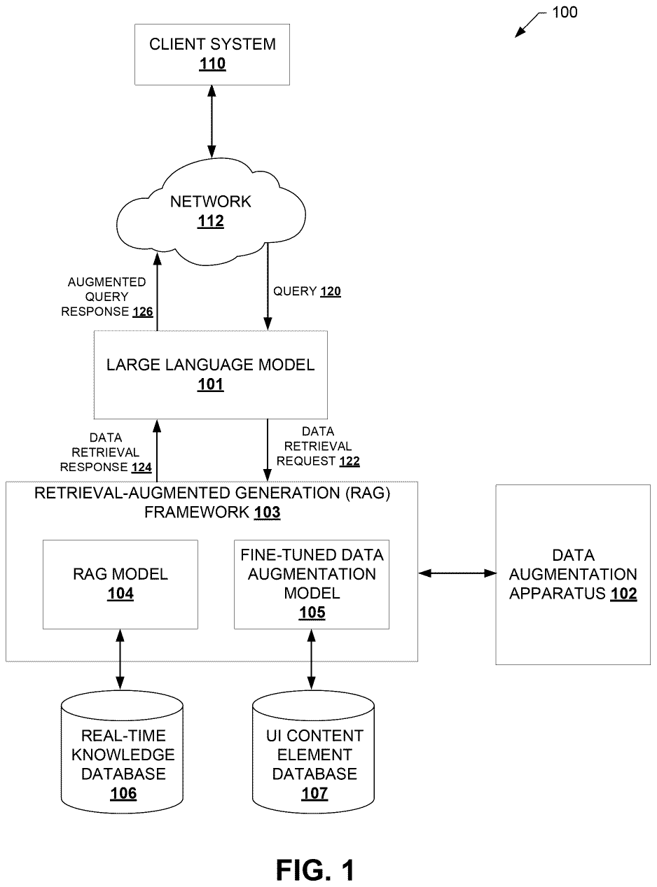

FIG. 1 illustrates a block diagram of a system that can be specially configured within which embodiments of the present disclosure may operate. Specifically, FIG. 1 illustrates an example system 100. The example system 100 includes a large language model 101, a data augmentation apparatus 102, a RAG framework 103, and a client system 110. The RAG framework 103 includes a RAG model 104 and a fine-tuned data augmentation model 105. The RAG model 104 may be communicatively coupled to a real-time knowledge database 106 and the fine-tuned data augmentation model 105 may be communicatively coupled to a UI content element database 107. In some embodiments, at least a portion of the real-time knowledge database 106 and/or the UI content element database 107 may be included in the RAG framework 103. In some embodiments, at least a portion of the real-time knowledge database 106 and/or the UI content element database 107 may be included in a third-party system. In one or more embodiments, the system 100 includes at least one network 112 that enables transmission of data between one or more subsystem(s) and/or device(s) of the system 100.

The data augmentation apparatus 102 includes one or more computer(s) embodied in hardware, software, firmware, and/or a combination thereof. In some embodiments, the data augmentation apparatus 102 includes one or more application server(s), database server(s), enterprise computing terminal(s), and/or the like that are configured to perform the functionality described herein. In some embodiments, the data augmentation apparatus 102 embodies or includes a backend system (e.g., one or more enterprise server(s)) that are communicable over one or more network(s) (e.g., via the Internet). Additionally or alternatively, in some embodiments, the data augmentation apparatus 102 includes one or more virtual computer(s) embodied in a software environment maintained via particular hardware, for example where the data augmentation apparatus 102 is maintained as a virtual environment on hardware of a central terminal supporting multiple software application(s). In some embodiments, the data augmentation apparatus 102 includes one or more hardware device(s) within the same physically defined space, such as a data warehouse, company headquarters, and/or the like associated with a particular entity. Alternatively or additionally, in some embodiments, the data augmentation apparatus 102 includes one or more hardware and/or software device(s) located remotely from one another and that communicate in conjunction with one another to provide the described functionality, for example embodied by one or more cloud computing system(s).

In some embodiments, the data augmentation apparatus 102 includes a plurality of sub-services that each support a portion of the functionality performed by the data augmentation apparatus 102. In some such embodiments, the plurality of sub-services may each be embodied by different hardware, software, firmware, and/or any combination thereof. Alternatively or additionally, in some embodiments, one or more of the sub-services share particular hardware, software, firmware, and/or any combination thereof. For example, in some embodiments, the data augmentation apparatus 102 may embody specially-configured software applications executed on shared hardware.

The large language model 101 may be a data entity that describes parameters, hyper-parameters, and/or defined operations of a rules-based, artificial intelligence, and/or machine learning model (e.g., model including at least one of one or more rule-based layers, one or more layers that depend on trained parameters, coefficients, and/or the like). The large language model 101 may include one or more large language models configured, trained (e.g., jointly, separately, etc.), and/or the like to generate data for a query 120. In some embodiments, the large language model 101 may be an AI agent. The large language model 101 may include one or more of any type of large language model including one or more supervised, unsupervised, semi-supervised, artificial intelligence models, machine learning models, reinforcement learning models, and/or the like. In some examples, the large language model 101 may include multiple models configured to perform one or more different stages of a generative modeling process. In some embodiments, parameters (e.g., coefficient(s), weight(s), biase(s), activation function(s) and/or action function type(s) of the large language model 101 where the activation function and/or function type is determined as part of training, clustering centroid(s)/medoid(s), partition(s), number of trees, tree depth, split parameters) of the large language model 101 are determined as a result of training the large language model 101 based at least in part on training hyperparameters (e.g., for supervised, semi-supervised, and reinforcement modeling) and/or by iteratively operating the large language model 101 according to the training hyperparameters(e.g., for unsupervised modeling).

In some embodiments, structural hyperparameter(s) of the large language model 101 may define component(s) of the architecture of the large language model 101 and/or their configuration/order, such as the configuration/order specifying which input(s) are provided to one component and which output(s) of that component are provided as input to other component(s) of the large language model 101; a number, type, and/or configuration of component(s) per layer; a number of layers of the large language model 101; a number and/or type of input nodes in an input layer of the model; a number and/or type of nodes in a layer; a number and/or type of output nodes of an output layer of the large language model 101; component dimension (e.g., input size versus output size); a number of trees; a maximum tree depth; node split parameters; minimum number of samples in a leaf node of a tree; and/or the like. The component(s) of the large language model 101 may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based architecture for the large language model 101 (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components of the large language model 101 may vary depending on the type of large language model 101.

Training hyperparameter(s) may be used as part of training or otherwise determining the large language model 101. In some examples, the training hyperparameter(s), in addition to the training data and/or input data, may affect determining the parameter(s) of the large language model 101. Accordingly, accuracy, precision, and/or recall of the large language model 101 may be optimally configured. In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the large language model 101 to reduce the loss determined by the loss function, learning rate scheduling, and/or the like. In some examples, the structural hyperparameters and/or the training hyperparameters may be determined by a hyperparameter optimization algorithm.

In some embodiments, the client system 110 may provide the query 120 to the large language model 101. The query 120 may be a user query and/or a search query provided to the large language model 101. For instance, the query 120 may be a data entity that describes a text-based search query for a search domain. In one or more embodiments, the query 120 comprises text, audio (e.g., voice audio content, etc.), video, haptic data, gesture data associated with one or more gestures, and/or a combination thereof. In some embodiments, the query 120 may include a structured and/or natural language sequence of text (e.g., one or more alphanumeric characters, symbols, etc.). In some embodiments, the query 120 may include (i) a natural language sequence of text that expresses a prompt, question, preference, statement and/or the like and/or (ii) one or more contextual query attributes for constraining a result for the natural language sequence of text.

The query 120 may be input to and/or processed by the large language model 101 to generate a data retrieval request 122 for the RAG framework 103. The data retrieval request 122 may include the natural language sequence of text and/or the one or more contextual query attributes associated with the query 120. Additionally, the data retrieval request 122 may be configured as an API data structure, a function call, or another type of specially-configured data to enable input to the RAG model 104 and/or the fine-tuned data augmentation model 105. Based on data associated with the data retrieval request 122, the RAG model 104 and the fine-tuned data augmentation model 105 may be utilized to generate a data retrieval response 124 for the large language model 101.

The data augmentation apparatus 102 supports the RAG framework 103 for providing the data retrieval response 124 related to the data retrieval request 122. In some embodiments, the data augmentation apparatus 102 may receive, from the large language model 101, the data retrieval request 122 associated with the query 120. In some embodiments, the data augmentation apparatus 102 may apply the RAG model 104 to data associated with the data retrieval request 122 to determine real-time knowledge data for a query response (e.g., augmented query response 126) associated with the query 120. In some embodiments, the data augmentation apparatus 102 may apply the fine-tuned data augmentation model 105 to the data associated with the data retrieval request 122 to determine contextual data associated with the data retrieval request 122. In some embodiments, the data augmentation apparatus 102 may query the UI content element database 107 based on the contextual data to determine a UI content element for the query response (e.g., the augmented query response 126). In one or more embodiments, the UI content element comprises text, audio (e.g., voice audio content, etc.), video, haptic data, and/or a combination thereof. In some embodiments, the UI content element may be associated with an advertisement. In one or more embodiments, the UI content element and the query 120 comprise a corresponding type of content. For example, the UI content element and the query 120 may both comprise text. In one or more alternate embodiments, the UI content element comprises a different type of content than the query 120. For example, the query 120 may comprise text and the UI content element may comprise audio and/or video. In another example, the query 120 may comprise audio (e.g., voice audio content) and the UI content element may comprise text and/or video. In some embodiments, the data augmentation apparatus 102 may generate the data retrieval response 124 for the large language model 101. In some embodiments, the data retrieval response 124 may comprise the real-time knowledge data and the UI content element for the query response (e.g., the augmented query response 126). In some embodiments, the data retrieval response 124 may be configured as an API data structure, a function call, or another type of specially-configured data to enable input to the large language model 101.

In some embodiments, the data augmentation apparatus 102 enables query response functionality associated with the client system 110. In some embodiments, the client system 110 is associated with a user identifier. In some embodiments, the client system 110 embodies a user device and/or end terminal accessible by a user to initiate functionality via the data augmentation apparatus 102. For example, in some embodiments, a user enters authentication credentials via the client system 110 that are validated to initiate an authenticated session associated with the data augmentation apparatus 102, such that the user may utilize the client system 110 to access functionality of the data augmentation apparatus 102 associated with an asset profile and/or data associated therewith. The client system 110 in some embodiments is utilized to initiate one or more indication(s) of a trusted processing request. Additionally or alternatively, in some embodiments, the client system 110 is utilized to render electronic interface(s) that provide details associated with performance optimization predictions and/or the like. In some such embodiments, the client system 110 operates as a front-end or user-facing application for accessing such functionality of the data augmentation apparatus 102.

In some embodiments, the data augmentation apparatus 102 supports automatically receiving data transmissions (e.g., the data retrieval request 122), for example embodied by API request(s), procedure call(s), and/or other digital data transfers, that embody a request. Additionally or alternatively, in some embodiments, the data augmentation apparatus 102 supports providing data (e.g., the data retrieval response 124) via for example embodied by API request(s), procedure call(s), and/or other digital data transfers, that embody a response.

The network 112 can be a communications network and/or can be configurable to be embodied in any of a myriad of network configurations. In some embodiments, the network 112 embodies a public network (e.g., the Internet). In some embodiments, the network 112 embodies a private network (e.g., an internal, localized, or closed-off network between particular devices). In some other embodiments, the network 112 embodies a hybrid network (e.g., a network enabling internal communication between particular connected devices and external communication with other devices). The network 112 in some embodiments includes one or more base station(s), relay(s), router(s), switch(es), cell tower(s), communications cable(s) and/or associated routing station(s), and/or the like. In some embodiments, the network 112 includes one or more computing device(s) controlled by individual entities (e.g., an entity-owner router and/or modem) and/or one or more external utility devices (e.g., Internet service provider communication tower(s) and/or other device(s)).

The computing devices of the system 100 may each communicate in whole or in part over a portion of one or more communication network(s), such as the network 112. For example, each of the components of the system 100 can be communicatively coupled to transmit data to and/or receive data from one another over the same and/or different wireless or wired networks embodying the network 112. Non-limiting examples of network configuration(s) for the network 112 include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary. Alternatively or additionally still, in some embodiments the network 112 enables communication to one or more other computing device(s) not depicted, for example client device(s) for accessing functionality of any of the subsystems therein via native and/or web-based application(s), and/or the like.

### Example Apparatus

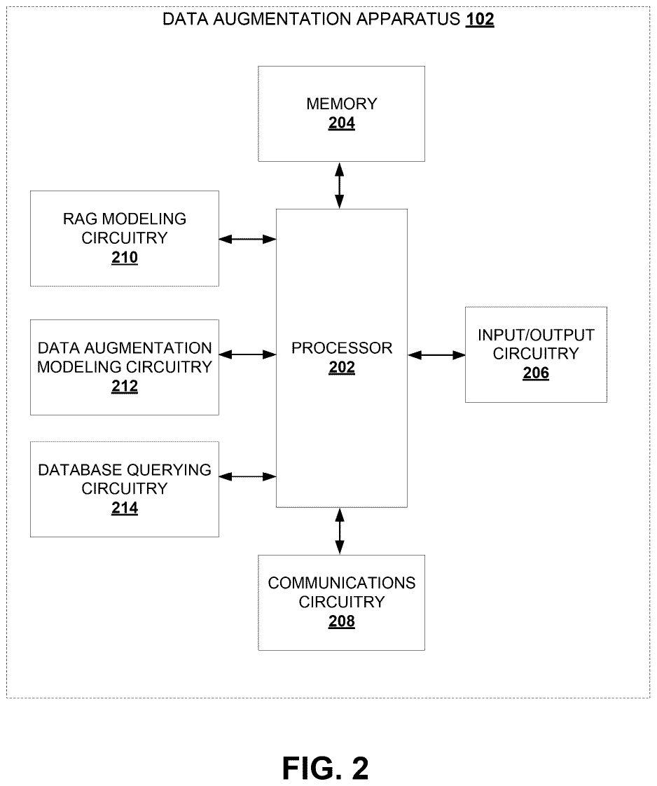

FIG. 2 illustrates a block diagram of an example apparatus that can be specially configured in accordance with at least one example embodiment of the present disclosure. Specifically, FIG. 2 illustrates the data augmentation apparatus 102 in accordance with at least one example embodiment of the present disclosure. The data augmentation apparatus 102 includes processor 202, memory 204, input/output circuitry 206, communications circuitry 208, RAG modeling circuitry 210, data augmentation modeling circuitry 212, and database querying circuitry 214. In some embodiments, the data augmentation apparatus 102 is configured, using one or more of the sets of circuitry 206, 208, 210, 212, and/or 214, to execute and perform one or more of the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the data augmentation apparatus 102 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the data augmentation apparatus 102 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the data augmentation apparatus 102. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the data augmentation apparatus 102 to carry out various functions in accordance with example embodiments of the present disclosure.

The processor 202 can be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the data augmentation apparatus 102, and/or one or more remote or “cloud” processor(s) external to the data augmentation apparatus 102.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes or is embodied by a CPU, microprocessor, and/or the like that executes computer-coded instructions, for example stored via the non-transitory memory 204.

In some embodiments, the data augmentation apparatus 102 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as an electronic interface, a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor can be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 includes hardware, software, firmware, and/or a combination thereof, that facilitates simultaneously display of particular data via a plurality of different devices.

In some embodiments, the data augmentation apparatus 102 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the data augmentation apparatus 102. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device, capture device, and/or other external computing device in communication with the data augmentation apparatus 102.

In some embodiments, the data augmentation apparatus 102 includes the RAG modeling circuitry 210. The RAG modeling circuitry 210 includes hardware, software, firmware, and/or a combination thereof, that supports various functionality associated with the RAG model 104. For example, in some embodiments, the RAG modeling circuitry 210 includes hardware, software, firmware, and/or a combination thereof, that applies the RAG model 104 to data (e.g., data associated with the data retrieval request 122) to determine real-time knowledge data. Additionally or alternatively, in some embodiments, the RAG modeling circuitry 210 includes hardware, software, firmware, and/or a combination thereof, that enables access to one or more API(s), FTP connection(s), and/or the like to securely acquire, receive, retrieve, and/or otherwise identify data from one or more system(s) external from the data augmentation apparatus 102 such as, for example, the data retrieval request 122. In some embodiments, the RAG modeling circuitry 210 includes a separate processor, specially configured field programmable gate array (FPGA), or a specially programmed application specific integrated circuit (ASIC).

In some embodiments, the RAG model 104 may include a retrieval mechanism configured to retrieve real-time knowledge data from the real-time knowledge database 106 based on data included in the data retrieval request 122. Additionally, the RAG model 104 may include a modeling mechanism associated with RAG modeling and/or MCP modeling. In some embodiments, the modeling mechanism may be associated with large language modeling. In some embodiments, the RAG model 104 may be or otherwise include a data entity that describes parameters, hyper-parameters, and/or defined operations of a rules-based, artificial intelligence, and/or machine learning model (e.g., model including at least one of one or more rule-based layers, one or more layers that depend on trained parameters, coefficients, and/or the like). The RAG model 104 may include one or more large language models configured, trained (e.g., jointly, separately, etc.), and/or the like to generate data for a query 120. The RAG model 104 may include one or more of any type of large language model including one or more supervised, unsupervised, semi-supervised, artificial intelligence models, machine learning models, reinforcement learning models, and/or the like. In some examples, the RAG model 104 may include multiple models configured to perform one or more different stages of a generative modeling process. In some embodiments, parameters (e.g., coefficient(s), weight(s), biase(s), activation function(s) and/or action function type(s) of the RAG model 104 where the activation function and/or function type is determined as part of training, clustering centroid(s)/medoid(s), partition(s), number of trees, tree depth, split parameters) of the RAG model 104 are determined as a result of training the RAG model 104 based at least in part on training hyperparameters (e.g., for supervised, semi-supervised, and reinforcement modeling) and/or by iteratively operating the RAG model 104 according to the training hyperparameters(e.g., for unsupervised modeling).

In some embodiments, structural hyperparameter(s) of the RAG model 104 may define component(s) of the architecture of the RAG model 104 and/or their configuration/order, such as the configuration/order specifying which input(s) are provided to one component and which output(s) of that component are provided as input to other component(s) of the RAG model 104; a number, type, and/or configuration of component(s) per layer; a number of layers of the RAG model 104; a number and/or type of input nodes in an input layer of the model; a number and/or type of nodes in a layer; a number and/or type of output nodes of an output layer of the RAG model 104; component dimension (e.g., input size versus output size); a number of trees; a maximum tree depth; node split parameters; minimum number of samples in a leaf node of a tree; and/or the like. The component(s) of the RAG model 104 may comprise one or more activation functions and/or activation function type(s) (e.g., GLU, such as an ReLU, leaky RELU, GELU, Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based architecture for the RAG model 104 (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components of the RAG model 104 may vary depending on the type of RAG model 104.

Training hyperparameter(s) may be used as part of training or otherwise determining the RAG model 104. In some examples, the training hyperparameter(s), in addition to the training data and/or input data, may affect determining the parameter(s) of the RAG model 104. Accordingly, accuracy, precision, and/or recall of the RAG model 104 may be optimally configured. In some examples, training hyperparameter(s) may comprise a train-test split ratio, activation function and/or activation function type (e.g., in examples like KANs where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the RAG model 104 to reduce the loss determined by the loss function, learning rate scheduling, and/or the like. In some examples, the structural hyperparameters and/or the training hyperparameters may be determined by a hyperparameter optimization algorithm.

In some embodiments, the data augmentation apparatus 102 includes the data augmentation modeling circuitry 212. The data augmentation modeling circuitry 212 includes hardware, software, firmware, and/or a combination thereof, that supports various functionality associated with the fine-tuned data augmentation model 105. For example, in some embodiments, the data augmentation modeling circuitry 212 includes hardware, software, firmware, and/or a combination thereof, that applies the fine-tuned data augmentation model 105 to data (e.g., data associated with the data retrieval request 122) to determine contextual data. Additionally or alternatively, in some embodiments, the data augmentation modeling circuitry 212 includes hardware, software, firmware, and/or a combination thereof, that enables access to one or more API(s), FTP connection(s), and/or the like to securely acquire, receive, retrieve, and/or otherwise identify data from one or more system(s) external from the data augmentation apparatus 102 such as, for example, the data retrieval request 122. In some embodiments, the data augmentation modeling circuitry 212 includes a separate processor, specially configured FPGA, or a specially programmed ASIC.

In some embodiments, the fine-tuned data augmentation model 105 may be or otherwise include a data entity that describes parameters, hyper-parameters, and/or defined operations of a rules-based, artificial intelligence, and/or machine learning model (e.g., model including at least one of one or more rule-based layers, one or more layers that depend on trained parameters, coefficients, and/or the like). The fine-tuned data augmentation model 105 may include one or more large language models configured, trained (e.g., jointly, separately, etc.), and/or the like to generate data for a query 120. The fine-tuned data augmentation model 105 may include one or more of any type of large language model including one or more supervised, unsupervised, semi-supervised, artificial intelligence models, machine learning models, reinforcement learning models, and/or the like. In some examples, the fine-tuned data augmentation model 105 may include multiple models configured to perform one or more different stages of a generative modeling process. In some embodiments, parameters (e.g., coefficient(s), weight(s), biase(s), activation function(s) and/or action function type(s) of the fine-tuned data augmentation model 105 where the activation function and/or function type is determined as part of training, clustering centroid(s)/medoid(s), partition(s), number of trees, tree depth, split parameters) of the fine-tuned data augmentation model 105 are determined as a result of training the fine-tuned data augmentation model 105 based at least in part on training hyperparameters (e.g., for supervised, semi-supervised, and reinforcement modeling) and/or by iteratively operating the fine-tuned data augmentation model 105 according to the training hyperparameters(e.g., for unsupervised modeling).

In some embodiments, structural hyperparameter(s) of the fine-tuned data augmentation model 105 may define component(s) of the architecture of the fine-tuned data augmentation model 105 and/or their configuration/order, such as the configuration/order specifying which input(s) are provided to one component and which output(s) of that component are provided as input to other component(s) of the fine-tuned data augmentation model 105; a number, type, and/or configuration of component(s) per layer; a number of layers of the fine-tuned data augmentation model 105; a number and/or type of input nodes in an input layer of the model; a number and/or type of nodes in a layer; a number and/or type of output nodes of an output layer of the fine-tuned data augmentation model 105; component dimension (e.g., input size versus output size); a number of trees; a maximum tree depth; node split parameters; minimum number of samples in a leaf node of a tree; and/or the like. The component(s) of the fine-tuned data augmentation model 105 may comprise one or more activation functions and/or activation function type(s) (e.g., GLU, such as an ReLU, leaky RELU, GELU, Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based architecture for the fine-tuned data augmentation model 105 (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components of the fine-tuned data augmentation model 105 may vary depending on the type of RAG model 104.

Training hyperparameter(s) may be used as part of training or otherwise determining the fine-tuned data augmentation model 105. In some examples, the training hyperparameter(s), in addition to the training data and/or input data, may affect determining the parameter(s) of the fine-tuned data augmentation model 105. Accordingly, accuracy, precision, and/or recall of the fine-tuned data augmentation model 105 may be optimally configured. In some examples, training hyperparameter(s) may comprise a train-test split ratio, activation function and/or activation function type (e.g., in examples like KANs where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the fine-tuned data augmentation model 105 to reduce the loss determined by the loss function, learning rate scheduling, and/or the like. In some examples, the structural hyperparameters and/or the training hyperparameters may be determined by a hyperparameter optimization algorithm.

In some embodiments, the data augmentation apparatus 102 includes the database querying circuitry 214. The database querying circuitry 214 includes hardware, software, firmware, and/or a combination thereof, that supports various functionality associated with querying the UI content element database 107. For example, in some embodiments, the database querying circuitry 214 includes hardware, software, firmware, and/or a combination thereof, that queries the UI content element database 107 based on contextual data determined by the fine-tuned data augmentation model 105. In some embodiments, the database querying circuitry 214 includes a separate processor, specially configured FPGA, or a specially programmed ASIC.

Additionally or alternatively, in some embodiments, two or more of the sets of circuitries 202-214 are combinable. Alternatively or additionally, in some embodiments, one or more of the sets of circuitry perform some or all of the functionality described associated with another component. For example, in some embodiments, two or more of the sets of circuitry 206-214 are combined into a single module embodied in hardware, software, firmware, and/or a combination thereof. Similarly, in some embodiments, one or more of the sets of circuitry, for example the RAG modeling circuitry 210, data augmentation modeling circuitry 212, and/or database querying circuitry 214, is/are combined with the processor 202, such that the processor 202 performs one or more of the operations described above with respect to each of these sets of circuitry 210-214.

### Example Data Flows for Providing Augmented Data Retrieval from a Data Source Using RAG Modeling

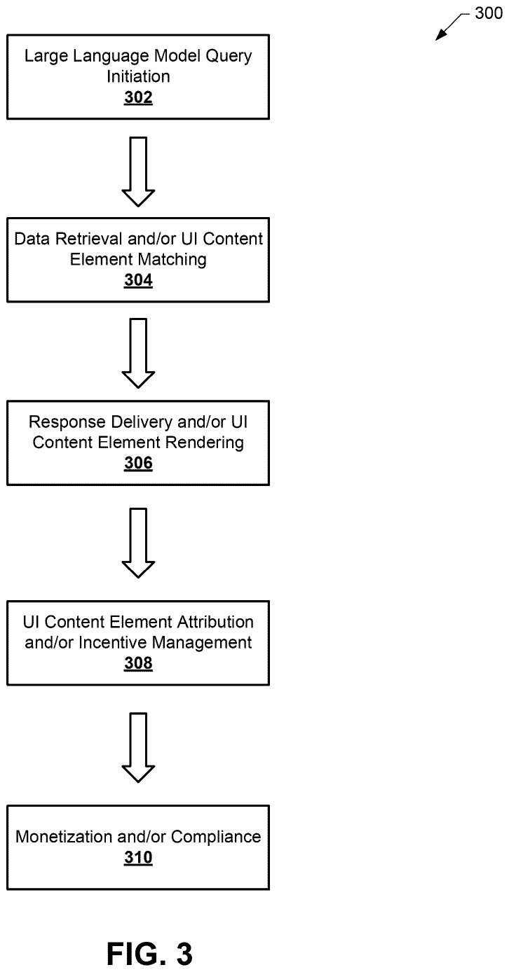

FIG. 3 illustrates an example data flow system 300 as part of a process for providing augmented data retrieval from a data source using RAG modeling and/or MCP modeling in accordance with at least one example embodiment of the present disclosure. Specifically, the data flow system 300 depicts functionality between the various sub-systems of the system 100, including the large language model 101, the data augmentation apparatus 102, the RAG framework 103, the RAG model 104, the fine-tuned data augmentation model 105, the real-time knowledge database 106, the UI content element database 107, the client system 110, and/or the network 112.

In some embodiments, the data flow system 300 includes a step 302 for providing large language model query initiation. For example, the large language model 101 may receive the query 120 from the client system 110. In one or more embodiments, the query 120 comprises text, audio (e.g., voice audio content, etc.), video, haptic data, gesture data associated with one or more gestures, and/or a combination thereof. Additionally, the large language model 101 may transmit the data retrieval request 122 to the RAG framework 103 via an API of the RAG framework 103. The data retrieval request 122 may include one or more parameters and/or data elements related to the query 120.

In some embodiments, the data flow system 300 includes a step 304 for providing data retrieval and/or UI content element matching. For example, the RAG model 104 may fetch real-time knowledge data from the real-time knowledge database 106 based on the data retrieval request 122. Additionally, the fine-tuned data augmentation model 105 may determine contextual data associated with the query 120 based on the data retrieval request 122. The fine-tuned data augmentation model 105 may determine the contextual data using taxonomy identification, intent analysis, topic extraction, keywork identification, temporal analysis, historical user data, geographical context, and/or other analysis techniques associated with the query 120. In some embodiments, the contextual data may include one or more taxonomy identifiers that are contextually relevant to the query 120, intent information associated with the query 120, one or more topics related to the query 120, and/or one or more keywords associated with the query 120. In some embodiments, the one or more taxonomy identifiers may be associated with one or more Interactive Advertising Bureau (IAB) content categories deemed relevant to the query 120. In some embodiments, the database querying circuitry 214 may query the UI content element database 107 based on the contextual data determined by the fine-tuned data augmentation model 105 to determine a UI content element for a query response (e.g., the augmented query response 126). In some embodiments, the database querying circuitry 214 utilizes an identity graph to predict cross-category relevance of the UI content element with respect to the real-time knowledge data and/or a user identifier associated with the query 120.

In some embodiments, the data flow system 300 includes a step 306 for providing response delivery and/or UI content element rendering. For example, the large language model 101 may receive the data retrieval response 124 from the RAG framework 103 and/or the data augmentation apparatus 102. The data retrieval response 124 may include the real-time knowledge data retrieved from the real-time knowledge database 106 using the RAG model 104. Additionally, the data retrieval response 124 may include the UI content element retrieved from the UI content element database 107 using the fine-tuned data augmentation model 105. In one or more embodiments, the UI content element comprises text, audio (e.g., voice audio content, etc.), video, haptic data, and/or a combination thereof. In some embodiments, the large language model 101 may determine text output for the augmented query response 126 based on the real-time knowledge data. Additionally, the large language model 101 may package the text output (e.g., the text output associated with the real-time knowledge data) and the UI content element in the augmented query response 126. Additionally, the large language model 101 may configure the real-time knowledge data and the UI content element for rendering via an electronic interface of the client system 110. For example, the text output (e.g., the text output associated with the real-time knowledge data) and the UI content element may be concurrently rendered via the electronic interface of the client system 110. In some embodiments, the UI content element may be contextually embedded within the augmented query response 126. In an embodiment where the UI content element comprises video, the video associated with the UI content element may be viewed via user interface prior to the augmented query response 126 being rendered via the user interface. For example, a user may view the video associated with the UI content element prior to being authorized to access the augmented query response 126.

In a non-limiting example, the augmented query response 126 may be structured as follows:

{
“message”: “The latest in AI startups is fascinating! Stay ahead in
tech! Get the latest gadgets at unbeatable prices. [Learn
more](https://RAGframework.com/advertiser/tech-deals)”,
}

In some embodiments, the data flow system 300 includes a step 308 for providing UI content element attribution and/or incentive management. For example, the large language model 101 may transmit a content attribution notification to the RAG framework 103 and/or the data augmentation apparatus 102 in response to the rendering of the text output (e.g., the text output associated with the real-time knowledge data) and the UI content element via the electronic interface of the client system 110.

In some embodiments, the data flow system 300 includes a step 310 for providing monetization and/or compliance. For example, the data augmentation apparatus 102 may generate an incentive for an entity identifier (e.g., a developer) associated with the large language model 101 in response to receiving the content attribution notification. In some embodiments, the data augmentation apparatus 102 may generate a payment request for an entity identifier (e.g., a developer) associated with the large language model 101 in response to a determination that a content attribution notification is not received for a rendered UI content element determined by the RAG framework 103. In some embodiments, the data augmentation apparatus 102 may additionally generate an incentive or payment request for an entity identifier (e.g., an advertiser, data provider, website host, AI model provider, verification partner, or other entity) associated with the UI content element in response to receiving the content attribution notification. For example, the incentive or payment request may include: an advertisement payment of $1.00 that is paid by an advertiser for the opportunity render the UI content element via the augmented query response 126, a data access cost of $0.50 to access RAG data via the RAG model 104, a revenue distribution of $0.50 for a data provider that provides the UI content element for the augmented query response 126, a system provider cost of $0.40 for providing the RAG framework 103 (e.g., infrastructure, AI orchestration, UI content element matching, and/or attribution workflows), and a website host cost of $0.10 to embed an AI experience for the RAG framework 103 via a network site.

FIG. 3 illustrates an example data flow system 400 as part of a process for providing augmented data retrieval from a data source using RAG modeling and/or MCP modeling in accordance with at least one example embodiment of the present disclosure. Specifically, the data flow system 400 depicts functionality between the various sub-systems of the system 100, including the large language model 101, the data augmentation apparatus 102, the RAG framework 103, the RAG model 104, the fine-tuned data augmentation model 105, the real-time knowledge database 106, the UI content element database 107, the client system 110, and/or the network 112.

In some embodiments, the data retrieval request 122 may be provided as input to the RAG model 104. Additionally, the data retrieval request 122 may be provided as input to the fine-tuned data augmentation model 105 in parallel to being provided to the RAG model 104. Based on data included in the data retrieval request 122, the RAG model 104 may generate real-time knowledge data 402 deemed relevant to the data included in the data retrieval request 122. In some embodiments, the RAG model 104 may query the real-time knowledge database 106 based on the data included in the data retrieval request 122 to determine the real-time knowledge data 402. Additionally, based on data included in the data retrieval request 122, the fine-tuned data augmentation model 105 may determine contextual data 404 associated with the data retrieval request 122. In some embodiments, the database querying circuitry 214 may perform a query process 405 to query the UI content element database 107 based on the contextual data 404. For example, the query process 405 may result in determination of a UI content element 406 from a plurality of UI content elements included in the UI content element database 107 based on the contextual data 404. As such, the UI content element 406 may be deemed a contextually relevant UI content element for the query 120, the real-time knowledge data 402, and/or a user identifier associated with the query 120. In one or more embodiments, the UI content element 406 comprises text, audio (e.g., voice audio content, etc.), video, haptic data, and/or a combination thereof. In one or more embodiments, the UI content element 406 and the query 120 comprise a corresponding type of content. For example, the UI content element 406 and the query 120 may both comprise text. In one or more alternate embodiments, the UI content element 406 comprises a different type of content than the query 120. For example, the query 120 may comprise text and the UI content element 406 may comprise audio and/or video. In another example, the query 120 may comprise audio (e.g., voice audio content) and the UI content element 406 may comprise text and/or video. In some embodiments, the database querying circuitry 214 may generate the data retrieval response 124. For example, the database querying circuitry 214 may package the real-time knowledge data 402 and the UI content element 406 into the data retrieval response 124. In some embodiments, the large language model 101 may generate the augmented query response 126 based on the data retrieval response 124 received from the RAG framework 103 and/or the data augmentation apparatus 102.

### Example Augmented Query Response

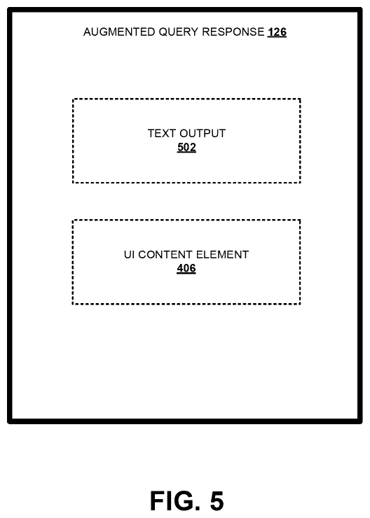

FIG. 5 illustrates an example augmented query response 126 in accordance with at least one example embodiment of the present disclosure. The augmented query response 126 may package text output 502 and the UI content element 406 based on the real-time knowledge data 402 and the UI content element 406 included in the data retrieval response 124. For example, the augmented query response 126 may be configured in a structured format for rendering via an electronic interface of the client system 110. In some embodiments, the augmented query response 126 may indicate an optimal rendering of the UI content element 406 with respect to the text output 502 via an electronic interface of the client system 110. In some embodiments, the large language model 101 may determine the text output 502 based on the real-time knowledge data 402. For example, the text output 502 may include a structured and/or natural language sequence of text (e.g., one or more alphanumeric characters, symbols, etc.) determined based on the real-time knowledge data 402. In some embodiments, the text output 502 may include a natural language sequence of text that expresses a response, answer, statement and/or the like.

In some embodiments, the text output 502 and the UI content element 406 may be configured for concurrent rendering via an electronic interface (e.g., a user interface, a graphical user interface, etc.) of the client system 110 in response to the query 120. For example, the text output 502 and the UI content element 406 may be configured for concurrent display via a display of the client system 110. In some embodiments, the UI content element may be contextually embedded within the text output 502.

In some embodiments, the electronic interface may be rendered as part of a particular application accessible via the client system 110. In some such embodiments, the application may embody a user-facing application providing access to functionality of the large language model 101. Alternatively or additionally, in some embodiments, the electronic interface may be renderable within a web application that is hosted by or otherwise grants access to the large language model 101, for example via accessing a particular web endpoint via a browser application on the client system 110. In some embodiments, a user may utilize authentication credentials to initiate an authenticated session associated with the electronic interface. In some embodiments, the user credentials can limit the user interaction with the electronic interface and/or the large language model 101 to only the functions authorized to the particular user (or system associated with the user). It will be appreciated that the electronic interface can include any number of a myriad of different interface element types to present one or more visualizations associated with the text output 502 and the UI content element 406. In some embodiments, the electronic interface may include one or more text labels, hyperlinks (e.g., where user interaction with the hyperlink initiates rendering of further detail associated with the data underlying the element with which the user interacted), one or more control elements, one or more interface buttons, and/or the like.

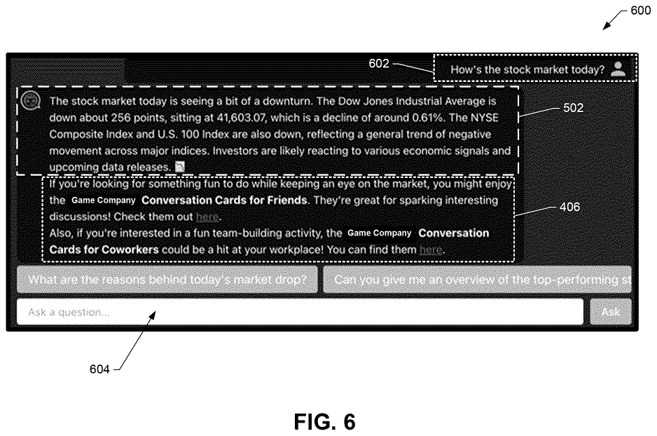

FIG. 6 illustrates an example electronic interface 600 in accordance with at least one example embodiment of the present disclosure. The electronic interface 600 may be configured to render an augmented query response (e.g., the augmented query response 126) in response to a data retrieval response being received from the RAG framework 103. For example, the augmented query response (e.g., the augmented query response 126) may include the text output 502 and the UI content element 406. In some embodiments, the electronic interface 600 may be a user interface, a web user interface, an application user interface, or another type of electronic interface for a display of the client system 110. Additionally, the electronic interface 600 may include an interactive user interface element 604 configured for receiving a prompt from a user. The prompt may be a free-form textual entry received from a user via the interactive user interface element 604. For example, the prompt may correspond to a user query 602 associated with a textual entry (e.g., “How's the stock market today?”). In some embodiments, the user query 602 may correspond to the query 120.

The electronic interface 600 may render the text output 502 and the UI content element 406 based on the real-time knowledge data 402 and the UI content element 406 included in the data retrieval response 124. For example, the augmented query response (e.g., the augmented query response 126) that includes the text output 502 and the UI content element 406 may be configured in a structured format for rendering via the electronic interface 600. In some embodiments, the augmented query response may indicate an optimal rendering of the UI content element 406 with respect to the text output 502 via the electronic interface 600. In some embodiments, the large language model 101 may determine the text output 502 based on the real-time knowledge data 402. Additionally, the text output 502 may include a structured and/or natural language sequence of text (e.g., one or more alphanumeric characters, symbols, etc.) determined based on the real-time knowledge data 402.

In some embodiments, the text output 502 may be generated in response to the user query 602 provided via the interactive user interface element 604. Additionally, the text output 502 may include a natural language sequence of text that expresses a response, answer, statement and/or the like. For example, the text output 502 may state “The stock market today is seeing a bit of a downturn. The Dow Jones Industrial Average is down about 256 points, sitting at 41,603.07, which is a decline of around 0.61%. The NYSE Composite Index and U.S. 100 Index are also down, reflecting a general trend of negative movement across major indices. Investors are likely reacting to various economic signals and upcoming data releases.”

In some embodiments, the RAG model 104 may be applied to the textual entry of the user query 602 to determine real-time knowledge data for the text output 502. Additionally, the fine-tuned data augmentation model 105 may be applied to the textual entry of the user query 602 to determine contextual data associated with the text output 502. The UI content element database 107 may also be queried based on the contextual data to determine the UI content element 406. As an example, the UI content element 406 may include a natural language sequence of text that expresses relevant content (e.g., an advertisement) associated with the text output 502. For example, the text output 502 may state “If you're looking for something fun to do while keeping an eye on the market, you might enjoy the Game Compnay Conversation Cards for Friends. They're great for sparking interesting discussions! Check them out here [hyperlink_1]. Also, if you're interested in a fun team-building activity, the Game Company Conversation Cards for Coworkers could be a hit at your workplace! You can find them here [hyperlink_2].”

In some embodiments, the text output 502 and the UI content element 406 may be configured for concurrent rendering via an electronic interface (e.g., a user interface, a graphical user interface, etc.) of the client system 110 in response to the user query 602. For example, the text output 502 and the UI content element 406 may be configured for concurrent display via a display of the client system 110. In some embodiments, the UI content element may be contextually embedded within the text output 502.

In some embodiments, the electronic interface 600 may be rendered as part of a particular application accessible via the client system 110. In some such embodiments, the application may embody a user-facing application providing access to functionality of the large language model 101. Alternatively or additionally, in some embodiments, the electronic interface 600 may be renderable within a web application that is hosted by or otherwise grants access to the large language model 101, for example via accessing a particular web endpoint via a browser application on the client system 110. In some embodiments, a user may utilize authentication credentials to initiate an authenticated session associated with the electronic interface 600. In some embodiments, the user credentials can limit the user interaction with the electronic interface 600 and/or the large language model 101 to only the functions authorized to the particular user (or system associated with the user). It will be appreciated that the electronic interface 600 can include any number of a myriad of different interface element types to present one or more visualizations associated with the text output 502 and the UI content element 406. In some embodiments, the electronic interface 600 may include one or more text labels, hyperlinks (e.g., where user interaction with the hyperlink initiates rendering of further detail associated with the data underlying the element with which the user interacted), one or more control elements, one or more interface buttons, and/or the like.

### Example Method(s)

Having described example systems and apparatuses, related data flows, and user interfaces in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depict a particular sequence of operations, the sequence can be altered without departing from the scope of the present disclosure. For example, some of the operations depicted can be performed in parallel or in a different sequence that does not materially affect the function of the processes.

The blocks indicate operations of each process. Such operations can be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart can be combinable, replaceable, and/or otherwise altered as described herein.

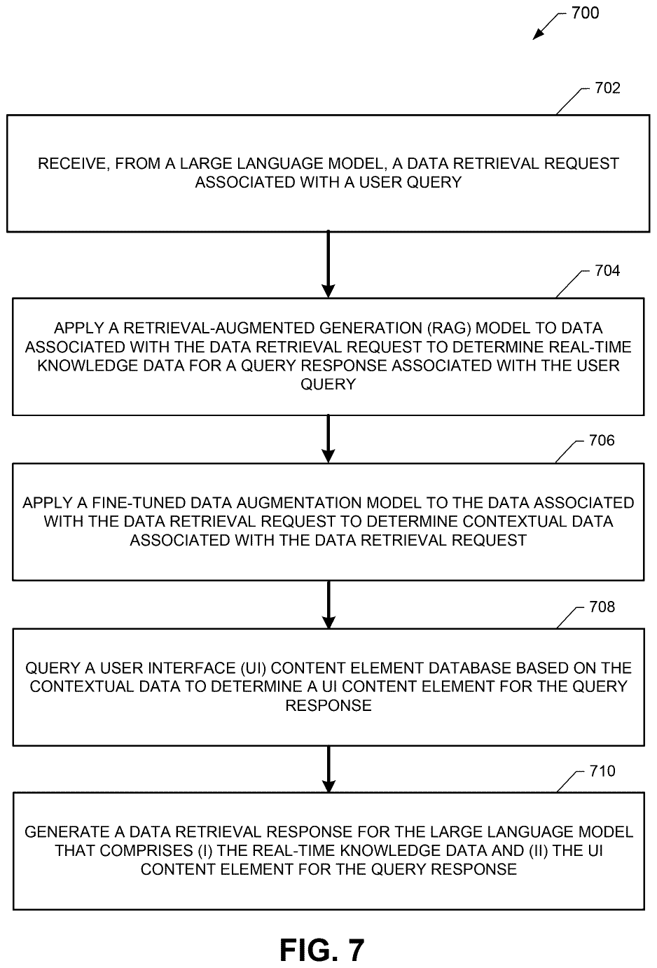

FIG. 7 illustrates a process 700 depicting example operations for providing augmented data retrieval from a data source using RAG modeling and/or MCP modeling in accordance with at least one embodiment of the present disclosure. The process 700 embodies an example computer-implemented method. In some embodiments, the process 700 is embodied by computer program code stored on a non-transitory computer-readable storage medium of a computer program product configured for execution to perform the process as depicted and described. Alternatively or additionally, in some embodiments, the process 700 is performed by one or more specially configured computing devices, such as the data augmentation apparatus 102 alone or in communication with one or more other component(s), device(s), system(s), and/or the like. In this regard, in some such embodiments, the data augmentation apparatus 102 is specially configured by computer-coded instructions (e.g., computer program instructions) stored thereon, for example in the memory 204 and/or another component depicted and/or described herein and/or otherwise accessible to the data augmentation apparatus 102, for performing the operations as depicted and described. In some embodiments, the data augmentation apparatus 102 is in communication with one or more external apparatus(es), system(s), device(s), and/or the like, to perform one or more of the operations as depicted and described. For example, the data augmentation apparatus 102 in some embodiments is in communication with a separate primary system, client system, and/or the like. For purposes of simplifying the description, the process 700 is described as performed by and from the perspective of the data augmentation apparatus 102.

According to some examples, the process 700 includes receiving, from a large language model, a data retrieval request associated with a user query, at block 702.

According to some examples, the process 700 includes applying a retrieval-augmented generation (RAG) model to data associated with the data retrieval request to determine real-time knowledge data for a query response associated with the user query, at block 704.

According to some examples, the process 700 includes applying a fine-tuned data augmentation model to the data associated with the data retrieval request to determine contextual data associated with the data retrieval request, at block 706.

According to some examples, the process 700 includes querying a user interface (UI) content element database based on the contextual data to determine a UI content element for the query response, at block 708.

According to some examples, the process 700 includes generating a data retrieval response for the large language model that comprises (i) the real-time knowledge data and (ii) the UI content element for the query response, at block 710.

In some embodiments, the data augmentation apparatus 102 transmits the data retrieval response to the large language model.

In some embodiments, the large language model generates the query response based on the real-time knowledge data. In some embodiments, the UI content element is concurrently rendered in combination with text output of the query response via a user interface.

In some embodiments, the RAG model utilizes memory-contextual processing (MCP) modeling to determine the real-time knowledge data for the query response.

In some embodiments, the data augmentation apparatus 102 generates an incentive for an entity identifier associated with the large language model in response to rendering of the UI content element in combination with text output of the query response via a user interface.

In some embodiments, the data augmentation apparatus 102 generates an incentive for an entity identifier associated with the UI content element in response to rendering of the UI content element in combination with text output of the query response via a user interface.

In some embodiments, the data augmentation apparatus 102 determines the UI content element based on taxonomy matching between the contextual data and the UI content element.

In some embodiments, the data augmentation apparatus 102 determines the UI content element based on predictive identity graphing process associated with the contextual data and the UI content element.

In some embodiments, the data augmentation apparatus 102 determines the UI content element based on intent associated with the user query.

In some embodiments, the data augmentation apparatus 102 contextually embeds the UI content element contextually within the real-time knowledge data.

In some embodiments, the UI content element and the user query comprise a corresponding type of content. For example, the UI content element and the query may both comprise text.

In some embodiments, the UI content element comprises a first type of content and the user query comprises a second type of content. For example, the user query may comprise text and the UI content element may comprise audio and/or video. In another example, the user query may comprise audio (e.g., voice audio content) and the UI content element may comprise text and/or video.

Although the process 700 depicts a particular sequence of operations, the sequence may be altered without departing from the scope of the present disclosure. For example, some of the operations depicted may be performed in parallel or in a different sequence that does not materially affect the function of the processes. Additionally, such operations may be performed in any of a number of ways, including, without limitation, in the order and manner as depicted and described herein. In some examples, the process 700 includes some or all operations described and/or depicted. Similarly, it should be appreciated that one or more of the operations of the process 700 may be combinable, replaceable, and/or otherwise altered as described herein.

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An apparatus comprising one or more processors and one or more storage devices storing instructions that are operable, when executed by the one or more processors, to cause the one or more processors to:
receive, from a large language model, a data retrieval request associated with a user query;
apply a retrieval-augmented generation (RAG) model to data associated with the data retrieval request to determine real-time knowledge data for a query response associated with the user query;
apply a fine-tuned data augmentation model to the data associated with the data retrieval request to determine contextual data associated with the data retrieval request;
query a user interface (UI) content element database based on the contextual data to determine a UI content element for the query response; and
generate a data retrieval response for the large language model that comprises (i) the real-time knowledge data and (ii) the UI content element for the query response.

2. The apparatus of claim 1, wherein the one or more storage devices store instructions that are operable, when executed by the one or more processors, to further cause the one or more processors to:
transmit the data retrieval response to the large language model.

3. The apparatus of claim 1, wherein the large language model generates the query response based on the real-time knowledge data, and wherein the UI content element is concurrently rendered in combination with text output of the query response via a user interface.

4. The apparatus of claim 1, wherein the RAG model utilizes memory-contextual processing (MCP) modeling to determine the real-time knowledge data for the query response.

5. The apparatus of claim 1, wherein the one or more storage devices store instructions that are operable, when executed by the one or more processors, to further cause the one or more processors to:
generate an incentive for an entity identifier associated with the large language model in response to rendering of the UI content element in combination with text output of the query response via a user interface.

6. The apparatus of claim 1, wherein the one or more storage devices store instructions that are operable, when executed by the one or more processors, to further cause the one or more processors to:
generate an incentive for an entity identifier associated with the UI content element in response to rendering of the UI content element in combination with text output of the query response via a user interface.

7. The apparatus of claim 1, wherein the one or more storage devices store instructions that are operable, when executed by the one or more processors, to further cause the one or more processors to:
determine the UI content element based on taxonomy matching between the contextual data and the UI content element.

8. The apparatus of claim 1, wherein the one or more storage devices store instructions that are operable, when executed by the one or more processors, to further cause the one or more processors to:
determine the UI content element based on predictive identity graphing process associated with the contextual data and the UI content element.

9. The apparatus of claim 1, wherein the one or more storage devices store instructions that are operable, when executed by the one or more processors, to further cause the one or more processors to:
determine the UI content element based on intent associated with the user query.

10. The apparatus of claim 1, wherein the one or more storage devices store instructions that are operable, when executed by the one or more processors, to further cause the one or more processors to:
contextually embed the UI content element within the real-time knowledge data.

11. The apparatus of claim 1, wherein the user query is associated with a first type of content and the UI content element is associated with a second type of content.

12. A computer-implemented method, comprising:
receiving, from a large language model, a data retrieval request associated with a user query;
applying a retrieval-augmented generation (RAG) model to data associated with the data retrieval request to determine real-time knowledge data for a query response associated with the user query;
applying a fine-tuned data augmentation model to the data associated with the data retrieval request to determine contextual data associated with the data retrieval request;
querying a user interface (UI) content element database based on the contextual data to determine a UI content element for the query response; and
generating a data retrieval response for the large language model that comprises (i) the real-time knowledge data and (ii) the UI content element for the query response.

13. The computer-implemented method of claim 12, further comprising:
transmitting the data retrieval response to the large language model.

14. The computer-implemented method of claim 12, wherein the large language model generates the query response based on the real-time knowledge data, and wherein the UI content element is concurrently rendered in combination with text output of the query response via a user interface.

15. The computer-implemented method of claim 12, further comprising:
generating an incentive for an entity identifier associated with the large language model in response to rendering of the UI content element in combination with text output of the query response via a user interface.

16. The computer-implemented method of claim 12, further comprising:
generating an incentive for an entity identifier associated with the UI content element in response to rendering of the UI content element in combination with text output of the query response via a user interface.

17. The computer-implemented method of claim 12, further comprising:
determining the UI content element based on taxonomy matching between the contextual data and the UI content element.

18. The computer-implemented method of claim 12, further comprising:
determining the UI content element based on predictive identity graphing process associated with the contextual data and the UI content element.

19. The computer-implemented method of claim 12, further comprising:
determining the UI content element based on intent associated with the user query.

20. One or more non-transitory computer-readable storage media storing instructions that, when executed by one or more processors, cause the one or more processors to:
receive, from a large language model, a data retrieval request associated with a user query;
apply a retrieval-augmented generation (RAG) model to data associated with the data retrieval request to determine real-time knowledge data for a query response associated with the user query;
apply a fine-tuned data augmentation model to the data associated with the data retrieval request to determine contextual data associated with the data retrieval request;
query a user interface (UI) content element database based on the contextual data to determine a UI content element for the query response; and
generate a data retrieval response for the large language model that comprises (i) the real-time knowledge data and (ii) the UI content element for the query response.
